(19) United States
(12) Patent Application Publication
(10) Pub. No.: US 2014/0347171 A1
(43) Pub. Date: Nov. 27, 2014

(54) Portable wireless tactile control device

(71) Applicant: Juan Carlos Ramiro, Fresnedoso de Ibor (ES)

(72) Inventor: Juan Carlos Ramiro, Fresnedoso de Ibor (ES)

(21) Appl. No.: 13/900,563

(22) Filed: May 23, 2013

(51) Int. Cl. G08C 17/02; G08B 6/00

(52) U.S. Cl. CPC G08C 17/02; G08B 6/00
USPC 340/12.5

(57) ABSTRACT

The proposed invention refers to a tactile device which generates control signals according to the signals detected when a finger is passed over the device and transmits the control signals to the receiver device which can be located elsewhere nearby which in turn transmits said signal to a user interface device such as a liquid crystal display, a computer, etc. and which, thanks to its reduced size and portability, means it can be used easily held in the palm of the hand.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Technical Field

The invention's technical field refers to the field of touch- and movement-sensitive electronic devices able to transmit wireless signals, and more particularly to the field of user interfaces for wireless touch- and movement-sensitive devices, making the reference industrial sector that of electronic device manufacturers.

2. Description of the Related Art

A touchpad is usually installed on electronic devices such as laptop computers or drawing tablets.

A surface sensitive to the touch of a finger is used to control the position of a cursor on a laptop display to make a selection, turn pages or send emails.

On the other hand, the touchpad is usually quite large, limiting its use.

The wish is thus for a smaller touchpad fitting into one hand and able to remote control a receiver device which might be located among other places on the temple of a pair of glasses, connecting to the Internet via a GSM or similar module and also allowing the receiver to access the Internet.

The inventor is unaware of any predecessor incorporating the elements of this invention, or the advantages thereof.

### BRIEF SUMMARY OF THE INVENTION

The invention proposed refers to a touchpad which generates control signals according to the signals detected when a finger is passed over the device and transmits the control signals to the receiver device which can be located elsewhere nearby, which in turn transmits said signal to a user interface device such as a liquid crystal display, a computer, etc. and which, thanks to its reduced size and portability, means it can be easily used held in the palm of the hand.

The device and its parts comprise essentially the following elements:

As associated elements fundamental for operation of the portable wireless touchpad which transmits its signal to a signal receiver located not far from the device and which in turn transmits the signal so generated to a user interface such as a liquid crystal display, led display or a laptop computer, the component parts of the wireless portable touchpad as such differentiated as follows:

The upper surface of the device, the touch-sensitive zone where the appropriate tasks will be performed depending on the type of movements made there.
The particular shape of the portable wireless device, of a substantially straight parallelepiped rectangular part with a rounded finish, is the consequence of the type of function it is to perform, so that vertical or horizontal displacements are controlled in the straight rectangular part while the circular movements occur on the device's rounded upper zone.
Thus the orders to the receiver are ordered according to the horizontal, vertical, diagonal or circular movements displacing the fingers over the surface.

An attachment ring is also seen through which to thread a tape or cord so that the device can be hung from the user's neck or simply secured as necessary, a USB connector to insert any other device fitted with that connector, a wifi reception and transmission module, an accelerometer, a bluetouch module, a signal processor, a communications module, a compartment for a rechargeable battery, a groove for a communications card, at least one on-off button also usable as a synchronisation component depending on how long it is held down, a menu control button which, apart from other functions given it, may unfold menu type information on the user interface display.

### BRIEF DESCRIPTION OF THE DRAWINGS

For a better understanding of the invention, five pages of plans are included, showing the following:

FIG. 1. A diagram of the layout of the main elements of the invention.

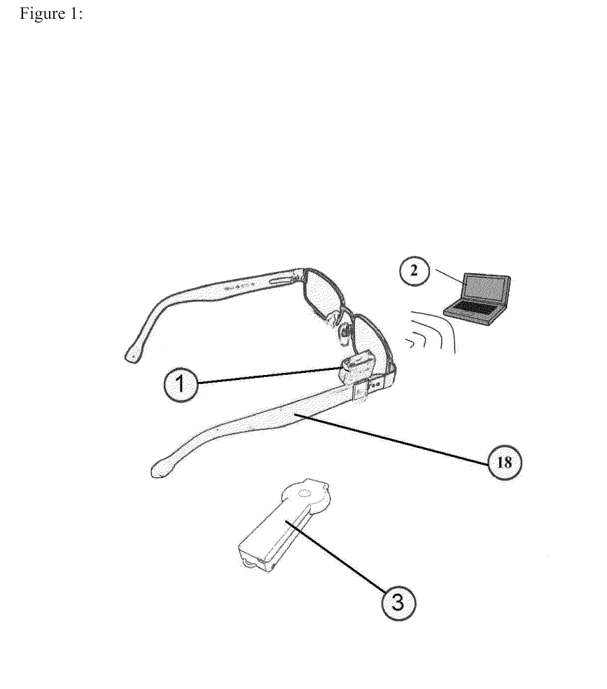

FIG. 2. A diagram of the in external components of the wireless touchpad.

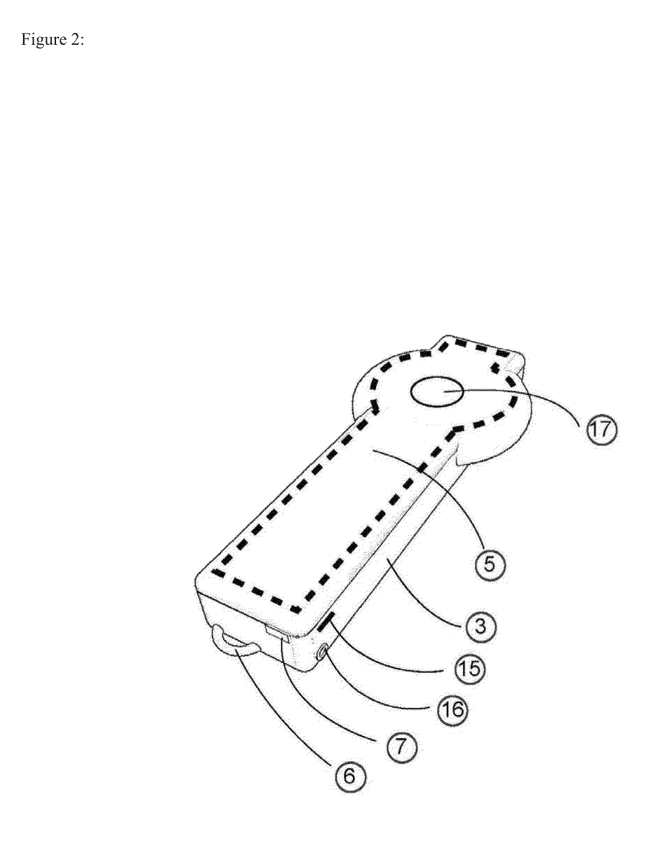

FIG. 3. A diagram of the main internal components of the wireless touchpad.

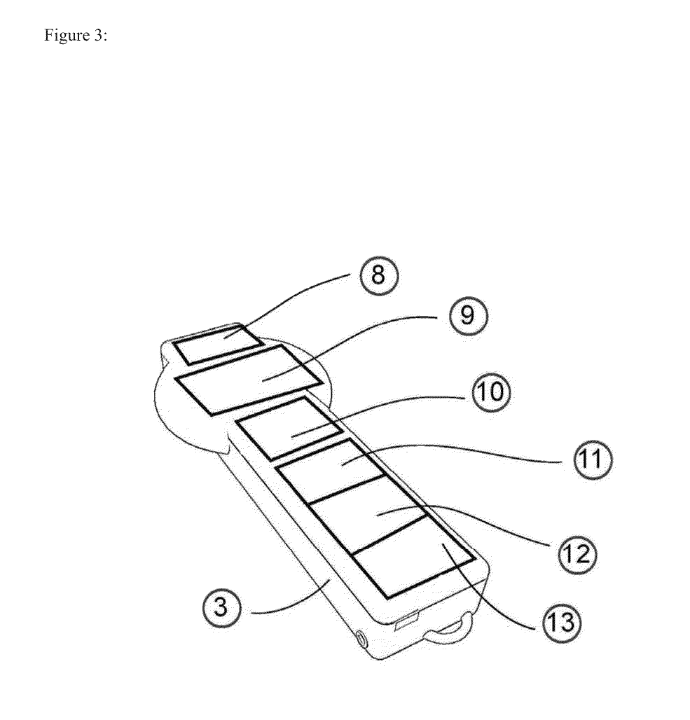

FIG. 4. A diagram of the tactile working areas of the wireless touchpad.

FIG. 5. A diagram of a hand holding a wireless touchpad.

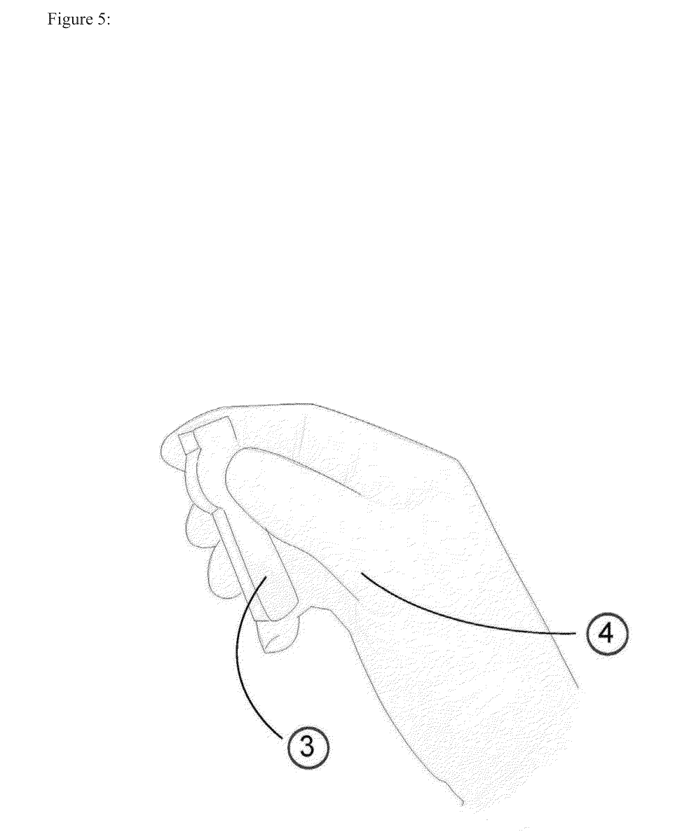

The following elements are seen in all of them

(1). a signal receiver

(2). a user interface

(3). the wireless touchpad

(4). a hand

(5). the touch-sensitive surface

(6). a ring

(7). a USE connector

(8). a Wi-Fi module

(9). an accelerometer

(10). a Bluetooth® module

(11). a signal processor

(12). a communications module

(13). a rechargeable battery

(14). indication of movements

(15). a groove for a communications card

(16). the on-off button

(17). the menu control button

(18). glasses

### DETAILED DESCRIPTION OF THE INVENTION

### Description of the Preferred Embodiment

The proposed invention refers to a tactile device, also known as a “touchpad”, which generates control signals according to the signals detected when a finger is passed over the device, and transmits the control signals to the receiver device which can be located elsewhere nearby which in turn transmits said signal to a user interface device (2) such as a liquid crystal display, a computer etc., and which, thanks to its reduced size and portability, means it can be used easily held in the palm of the hand (4).

The device and its parts comprise essentially the following elements:

As associated elements fundamental for the operation of the portable wireless touchpad which transmits its signal to a signal receiver (1) located not far from the device and which in a preferential embodiment might be placed on the temple of a pair of glasses (18) which in turn transmits the signal so generated to a user interface such as a liquid crystal display, led display or a laptop computer:

The component parts of the portable wireless touchpad (3) as such are differentiated as follows:

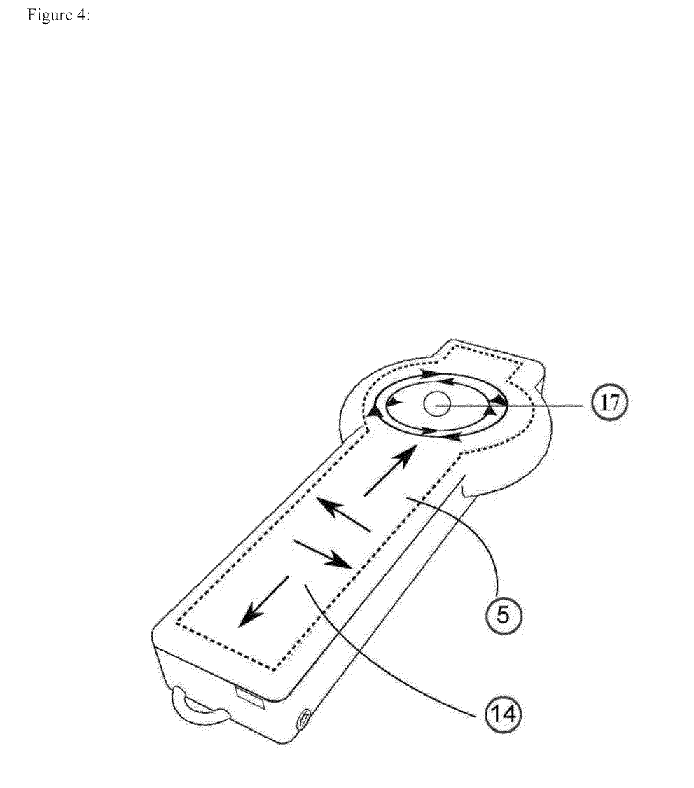

(5). the upper surface of the device, the touch-sensitive zone where the appropriate tasks will be performed depending on the type of movements made there.
The particular shape of the portable wireless device, of a substantially straight parallelepiped rectangular part with a rounded finish, is the consequence of the type of function it is to perform, as illustrated in FIG. 4.
Thus vertical or horizontal displacements are controlled in the straight rectangular part while the circular movements occur on the device's rounded upper zone.
Thus the orders to the receiver (1) are ordered according to the horizontal, vertical, diagonal or circular movements displacing the fingers over the surface (5).

(6). an attachment ring allowing a tape or cord to be threaded through so that the device can be hung from the user's neck or simply secured as necessary,

(7). a USE connector to insert any other device fitted with that connector.

(8) a Wi-Fi reception and transmission module,

(9) an accelerometer,

(10) a Bluetooth® module,

(11) a signal processor,

(12) a communications module,

(13) a rechargeable battery,

(15) a groove for a communications card,

(16) an on-off button also usable as a synchronisation component depending on how long it is held down,

(17) a menu control button which, apart from other functions given it, may unfold menu type information on the user interface display (2).

Having sufficiently described the nature of the invention and the means for putting it into practice, it must be recorded that the foregoing arrangements indicated and shown in the attached drawings may undergo modifications of detail as long as that does not alter their fundamental principles defined in the preceding paragraphs and summarised in the following claims.

1. A PORTABLE WIRELESS TACTILE CONTROL DEVICE which generates control signals according to the signals detected when a finger is passed over the device and transmits the control signals to the receiver device which can be located elsewhere nearby, which in turn transmits said signal to a user interface device (2) of characteristic portability thanks to its reduced size and configuration and characterised by comprising at least the following elements:
(5). upper surface of the device, the touch-sensitive zone where the appropriate tasks will be performed depending on the type of movements made there.
The particular shape of the portable wireless device, of a substantially straight parallelepiped rectangular part with a rounded finish, is the consequence of the type of function it is to perform, so that vertical or horizontal displacements are controlled in the straight rectangular part while the circular movements occur on the device's rounded upper zone.
(6). an attachment ring through which a tape or cord can be threaded,
(7). a USB connector to insert any other device fitted with that connector,
(8). a Wi-Fi reception and transmission module,
(9). an accelerometer,
(10). a Bluetooth® module,
(11). a signal processor,
(12). a communications module,
(13). a rechargeable battery,
(15). a groove for a communications card,
(16). on on-off button,
(17). a menu control button which unfolds menu type information on the user interface display (2).

2. A PORTABLE WIRELESS TACTILE CONTROL DEVICE which generates control signals according to the signals detected when a finger is passed over the device and transmits the control signals to the receiver device which can be located elsewhere nearby, which in turn transmits said signal to a user interface device (2) of characteristic portability thanks to its reduced size and configuration according to claim l and characterised in that the signals receiver can be located on the temple of a pair of glasses.

3. A PORTABLE WIRELESS TACTILE CONTROL DEVICE which generates control signals according to the signals detected when a finger is passed over the device and transmits the control signals to the receiver device which can be located elsewhere nearby, which in turn transmits said signal to a user interface device (2) of characteristic portability thanks to its reduced size and configuration according to claim 1 and characterised in that the button (16) can also be used as synchronisation element depending on how long it is held down.

1. A PORTABLE WIRELESS TACTILE CONTROL DEVICE which generates control signals according to the signals detected when a finger is passed over the device and transmits the control signals to the receiver device which can be located elsewhere nearby, which in turn transmits said signal to a user interface device (2), of characteristic portability thanks to its reduced size and configuration according to claim 1 and characterised in that the button (17) may also have functions to assign other than unfolding the menu.
